(19) United States
(12) Patent Application Publication
(10) Pub. No.: US 2018/0257692 A1
(43) Pub. Date: Sep. 13, 2018

(54) SYSTEM FOR BLOCKING THE RADIAL MOVEMENT OF A STEERING COLUMN

(71) Applicant: ROBERT BOSCH AUTOMOTIVE STEERING VENDÔME, Vendome (FR)

(72) Inventors: Mickael SAUQUET, Villerable (FR); William CHARVET, Chambray les Tours (FR); Nicolas GENET, Coulommiers la Tour (FR)

(21) Appl. No.: 15/743,650

(22) PCT Filed: Jul. 11, 2016
(86) PCT No.: PCT/FR2016/051778

§ 371 Date: Jan. 10, 2018

(30) Foreign Application Priority Data
Jul. 10, 2015 (FR) 1556595

(51) Int. Cl. B62D 1/184; B62D 1/189

(52) U.S. Cl. CPC B62D 1/184; B62D 1/189

(57) ABSTRACT

Some embodiments are directed to a steering column that includes a steering member articulated in rotation to a support base intended to be fixed with respect to the chassis of a vehicle, a clamp so as to be able to lock the steering member on the support base, first blocking shapes borne by a mobile clamping element, and second blocking shapes borne by a sheet-metal plate blocked against the support base. The first blocking shapes are able, during locking, to come and engage between the second blocking shapes so as to block the rotation of the steering member with respect to the support base.

### CROSS REFERENCE TO RELATED APPLICATIONS

This application is a national phase filing under 35 C.F.R. § 371 of and claims priority to PCT Patent Application No. PCT/FR2016/051778, filed on Jul. 11, 2016, which claims the priority benefit under 35 U.S.C. § 119 of French Patent Application No. 1556595, filed on Jul. 10, 2015, the contents of each of which are hereby incorporated in their entireties by reference.

### BACKGROUND

Some embodiments relate to an adjustable vehicle steering column, and more particularly to a steering column that can be adjusted by rotation with respect to a support base fixed to the chassis of the vehicle.

Some of the embodiments are directed to a steering column for a motor vehicle.

Steering columns transmit the rotation of the steering wheel to the wheels in order to modify the orientation thereof, for example in the following order: from the steering wheel to the steering column, the intermediate shaft, the rack and finally the wheels.

Related art steering columns allow reach and/or rake adjustment of the steering wheel.

A related art steering column includes:
a steering member intended to be connected to a vehicle steering wheel,
a support base supporting this member, and
a clamp arranged so as to be able to lock the steering member on this support base.

In related art steering columns, heightwise rake adjustment is achieved by rotating the steering member about a horizontal axis mounted on the support base. This is then referred to as radial adjustment.

### SUMMARY

Because of the angle at which the steering column is installed in the vehicle and because of the path followed by the driver colliding with the steering wheel or with the airbag, the resultant load on the steering column has a vertical component which may cause the steering wheel to move towards the position of uppermost radial adjustment. In order to have enhanced or optimum airbag deployment, it is necessary to avoid this vertical movement during the crash and it is therefore necessary to introduce a system for blocking the vertical adjustment, in addition to the usual clamping.

The simplest related art solution is to block the vertical movement by providing a sufficiently high level of friction on each side of the clamping system. Friction systems have a limited level of resistive load and increasing the number of sliding surfaces makes it possible to achieve the desired performance only at the expense of systems that are bulky and may be noisy and economically expensive.

More commonplace related art solutions add a system with teeth between a fixed component and a component that is mobile in vertical adjustment. However, even though these toothed systems make it possible to provide high retention load in a small amount of space, they require numerous additional components, some of which are more complex to manufacture.

Some embodiments therefore provide a system for blocking the movement of the steering member with respect to its support on the chassis of the vehicle that guarantees high load while at the same time being easier to manufacture.

To this end, one embodiment is directed to a steering column including:
a steering member intended to be connected to a vehicle steering wheel, notably via a tube,
a support base, notably a cover, intended to be mounted fixedly with respect to a vehicle chassis, the steering member being mounted articulated in rotation to this support base, and
a clamp borne by the steering member and including a mobile clamping element, the clamp being arranged so as to be able to lock the steering member on the support base by clamping of the mobile element against the support base.

This steering column includes:
second blocking shapes borne by a sheet-metal plate, the latter being blocked against this support base,
first blocking shapes borne by the mobile clamping element,
   the steering column being arranged in such a way that the first blocking shapes are able, during locking of the steering member on the support base by clamping of the mobile element against the support base, to come and engage between the second blocking shapes so as to block the rotation of the steering member with respect to the support base.

Thus, in addition to the clamping that allows the steering member to be locked with respect to the chassis, this steering column according to the embodiments includes a mechanism that safeguards the blocking of the rotation of the steering member with respect to its support base. By using blocking shapes secured to a component that is mobile in terms of vertical adjustment, namely the first blocking shapes secured to the steering member, which become lodged between blocking shapes secured to a fixed component, namely the second blocking shapes secured to the support base, strong clamping inherent to a toothed blocking system is obtained. However, the first blocking shapes are borne by the mobile element that already provides clamping for locking. As a result, that allows the mobile element to fulfil the dual function of locking by clamping in one direction and of blocking by teeth in another direction. That makes for one fewer component in this steering column, which is therefore simpler to produce.

In addition, creating the second blocking shapes on a sheet-metal plate allows a simple design of these blocking shapes. For example, the sheet-metal plate with the blocking shapes may be obtained by cutting. Cutting is simpler to perform. It also makes it possible to obtain more precise shapes than are obtained by pressing. In particular, that makes it possible easily to obtain rows of teeth on this plate.

Moreover, because the sheet-metal plate is distinct from the support base, the manufacture of these second blocking shapes can be performed independently of the manufacture of the support base, making it possible to avoid making the manufacture of this support base any more complex.

The support base may for example be formed of pressed sheet metal. This technique is more appropriate for a support base made of sheet metal, the latter having a certain thickness.

The sheet-metal plate is said to be blocked against the support base because it does not slide along the latter and remains constantly in contact therewith. For example, the sheet-metal plate may be fixed to the support base, notably by clip-fastening, welding or screwing. In another example, the sheet-metal plate may be blocked without fixing, for example by arranging the sheet-metal plate always under tension between the mobile element and the wall of the cover against which it is blocked. In this last example, the sheet-metal plate may include elastic portions pressing against the cover and the mobile element, designed to be sufficiently under strain when the steering column is in the unlocked position to keep the sheet-metal plate blocked.

Some embodiments may optionally exhibit one or more of the following features:
the first blocking shapes and the second blocking shapes are teeth; this is a simple way of embodying blocking shapes to allow the mobile element to engage with the sheet-metal plate, and thus indirectly with the support base; it also allows blocking in both directions, and therefore prevents any pivoting movement of the steering member about the pivot axis either, when the steering column is mounted in the vehicle, upwards or downwards;
the teeth have their end faces arranged facing the blocking wall; that allows the teeth between the mobile clamping element and the sheet-metal plate to be disengaged with a movement of the mobile clamping element corresponding to the thickness of the teeth; thus this movement is smaller than when the teeth are perpendicular to the blocking wall (specifically, with perpendicular teeth it is necessary to have a larger movement which corresponds to the height of the teeth); in addition, with end-face teeth it is possible to increase the height of these teeth without affecting the amplitude of the movement needed for clamping, these teeth thus having better strength;
the steering column may be arranged in this way:
   the teeth borne by the sheet-metal plate point towards the outside of the sheet-metal plate, notably the teeth are arranged on one or more edge of the sheet-metal plate, and/or
   the teeth borne by the mobile clamping element point towards a midplane of this mobile clamping element;

that allows the teeth of the cam to come on either side of the sheet-metal plate and afford better blocking;
the sheet-metal plate includes two rows of teeth; in this case, the teeth of each row point in a direction away from the other row, because they point outwards;
the mobile clamping element includes two rows of teeth; the teeth of one row may point towards the teeth of the other row;
the sheet-metal plate is made of a cut metal sheet, the second blocking shapes being obtained by cutting;
the sheet-metal plate has undergone a heat treatment, in particular the sheet-metal plate is made of tempered steel; the sheet-metal plate thus exhibits better strength; because the sheet-metal plate is a distinct component, this heat treatment can in this case be confined to the sheet-metal plate before it is attached to the support base, thus reducing the cost of treatment;
the sheet-metal plate is made of stainless steel; this stainless steel may contain more than 10.5% chromium, as a percentage of the total mass of the steel;
the clamp includes a clamping screw arranged in such a way as to be able to drive the mobile clamping element into a locking position in which the mobile clamping element is clamped against the sheet-metal plate and to be able to move the mobile clamping element away from the sheet-metal plate towards an unlocking position; the mobile element may be a cam driven in longitudinal movement along the axis of the clamping screw by actuation of a follower cam borne by the clamping screw;
the mobile clamping element is made of a sintered steel; that makes it possible to avoid needing to rework the mobile clamping element after it leaves the tooling used to form it; in addition, the mobile clamping element is thus stronger;
the mobile clamping element and the first blocking shapes form one single component;
the mobile clamping element is a cam; notably the mobile element includes a first side oriented towards the sheet-metal plate and bearing the first blocking shapes and a second side including ramps; the clamp may include a clamping screw and camways that can be made to rotate by the clamping screw, the camways and the ramps being arranged in such a way that rotation of the camways gives rise to a translational movement of the cam;
the support base includes a blocking wall against which the sheet-metal plate is fixed, and in that the sheet-metal plate includes elastic portions some distance away from the blocking wall and distinct from the second blocking shapes, these elastic portions and the mobile clamping element being arranged in such a way that when the latter is clamped against the sheet-metal plate, it moves these elastic portions against this blocking wall, thus placing these elastic portions under elastic strain; the elastic portions will thus allow the mobile element to be moved more easily away from the blocking wall and therefore allow easier disengagement of the first blocking shapes from the second blocking shapes; thus, disengagement of the teeth during locking becomes easier; with this option, the sheet-metal plate itself forms an elastic device, which is placed under strain during locking of the steering member on the support base, and which facilitates disengagement of the first blocking shapes and of the second blocking shapes during unlocking of the steering member on the support base;
the sheet-metal plate includes slots delimiting, with the edges of the sheet-metal plate, metal strips that form the elastic portions;
the steering column includes an elastic element mounted between the mobile clamping element and the steering member notably by passing through a central opening in the sheet-metal plate and a hole in the blocking wall, this elastic element being arranged in such a way that its strain increases as the mobile clamping element is clamped against the sheet-metal plate; this element makes it easier to move the mobile element away from the blocking wall;
the support base includes a blocking wall on which the sheet-metal plate is blocked, and the sheet-metal plate includes at least one portion forming a metal leaf which bears all or some of the complementary second shapes, the metal leaf being arranged in such a way that when the mobile clamping element is some distance away from the sheet-metal plate, the metal leaf is some distance away from the blocking wall, so that if, during clamping, the first blocking shapes come to press on the second blocking shapes, this metal leaf moves towards the blocking wall, thus placing this metal leaf under elastic strain; and so, even if, during clamping, the first blocking shapes become offset so that they do not become lodged between the first blocking shapes, there will nevertheless be a force exerted on the fixing face and the steering member will nevertheless be kept clamped to the support base; in the event of the vehicle being involved in a collision, the first blocking shapes will quickly become lodged between the second blocking shapes;
the sheet-metal plate includes a frame with a central opening, and the clamp includes a clamping screw passing through this central opening; this then yields a compact embodiment;
the cam includes slides arranged inside the central opening so as to be able to slide against the edges of the central opening; that provides guidance for the cam with respect to the sheet-metal plate when adjusting the steering column;
the steering column is adjustable in rotation about a pivot axis and the edges of the central opening may exhibit edges that are slightly curved, notably with curvatures corresponding to an arc of a circle centred on the pivot axis and in a plane perpendicular to this pivot axis;
the sheet-metal plate includes an outer frame, the frame with the central opening being inside this outer frame and connected thereto by spacer pieces, the second blocking shapes being borne by the frame with the central opening or by the outer frame;
the outer frame is arranged in such a way as to form spring leaves, the second blocking shapes being borne by the frame with the central opening; this then is a simple way of producing the second blocking shapes separately from the means that assist with the disengagement of the first and second blocking shapes;
the spring leaves may be formed by folds, curves or cutouts on the outer frame such that certain parts of the outer frame are offset from certain other parts; certain parts of the outer frame are thus arranged against the blocking wall and others away from these, when the steering column is unlocked;
the outer frame is arranged in such a way that during clamping of the mobile element against the support base, this outer frame is clamped in a vice-like grip between the mobile element and the support base; this is one way of transferring the clamping load to the support base;
the sheet-metal plate includes a single frame, namely the frame with the central opening, the second blocking shapes being borne by this single frame; this is a sheet-metal plate that is very simple to produce;
in the case of the preceding paragraph, it is possible to produce the mobile clamping element with at least one elastic element as described hereinabove, to contribute to the moving of the mobile element away from the blocking wall;
in the instance in which the sheet-metal plate includes a single frame, the mobile clamping element and the sheet-metal plate are arranged in such a way that, during clamping, the mobile clamping element presses directly against the support base; this is one way of transferring the clamping load to the support base; for example, the mobile clamping element includes contact portions facing the support base, these contact portions being arranged in a manner that is offset towards the support base with respect to the first blocking shapes borne by the mobile clamping element, so that, during locking, these contact portions press directly against the support base;
the support base includes a blocking wall against which the sheet-metal plate is blocked, the blocking wall including studs arranged on either side of this central frame, preferably as a close fit, so as to block the sheet-metal plate, so as to contribute to the blocking of the rotation of the steering member with respect to the support base; notably the studs may be arranged between the outer frame and the central frame; the studs may be four in number;
in the instance in which the sheet-metal plate includes a frame with a central opening and an outer frame, the studs may be fitted between the frame with the central opening and the outer frame; that allows the sheet-metal plate to be held firmly and avoids torsional loading between these two frames; alternatively, the studs may be produced in such a way that they fit inside the central opening and against the edges of the frame with the central opening;
the support base includes a blocking wall on which the sheet-metal plate is blocked, this blocking wall including fixing holes, and in that the sheet-metal plate includes fixing tabs, the tabs being fitted into the fixing holes in such a way as to fix the sheet-metal plate to the blocking wall; that allows the sheet-metal plate to be fixed in a simple way and thus blocked on the support base;
the support base includes a blocking wall on which the sheet-metal plate is blocked, and in addition the sheet-metal plate may include a load-reacting shape, the sheet-metal plate including a bow forming a slot in the sheet-metal plate, this load-reacting shape being arranged in this slot in such a way that opposite edges of this load-reacting shape are in contact with corresponding edges of this slot; that makes it possible to prevent a translational or rotational movement in a direction from one opposite edge to the other;
the load-reacting shape is an arch and in that the sheet-metal plate includes a bar extending from one edge of the slot formed by the bow, this bar being designed to slide under strain under the arch; that allows the sheet-metal plate to be pressed firmly against the blocking wall and absorb vibrations; this reduces noise when the vehicle equipped with this steering column is being used;
the support base includes a blocking wall on which the sheet-metal plate is blocked, and in addition the sheet-metal plate may include an elastic engagement device, notably at the top and bottom of the sheet-metal plate, allowing the sheet-metal plate to be fitted onto the blocking wall, notably in an upwards vertical movement;
the support base includes a blocking wall on which the sheet-metal plate is blocked, and in addition, the sheet-metal plate may have a bent-over edge that allows the sheet-metal plate to be fitted onto the blocking wall; that simplifies the mounting of the sheet-metal plate that the support base; this bent-over edge may be on the bottom of the sheet-metal plate;
the support base includes two clamping walls arranged on either side of the steering member, each of these walls including an oblong hole, the clamp including a clamping screw passing through the oblong holes, which are arranged in such a way that the clamping screw can be mobile in rotation with respect to the support base and as one with the steering member as the latter rotates with respect to the support base, one of these walls being a blocking wall to which the sheet-metal plate is fixed; the sheet-metal plate may include a central hole facing the oblong holes, the clamping screw also passing through this central hole and being mobile therein as the steering member is adjusted.

### BRIEF DESCRIPTION OF THE FIGURES

Further features and advantages of some embodiments will become apparent from reading the detailed description of the nonlimiting examples which follow, for the understanding of which reference will be made to the attached drawings, among which:

FIG. 1 is a perspective view of a steering column according to the invention;

FIG. 2 is an exploded view of FIG. 1;

FIG. 3a is a side view of FIG. 1;

FIG. 3b illustrates the view obtained in the cross section along offset planes in FIG. 3a, the offset planes being perpendicular to the axis of the steering column A and indicated in FIG. 3a by the line EE′;

FIG. 4 is a perspective view of one of the faces of the sheet-metal plate, this face being intended to face the mobile element;

FIG. 5 is a perspective view of the sheet-metal plate of FIG. 4, but viewed from the other side;

FIG. 6 is a perspective view of the support base of FIG. 1;

FIG. 7 is a perspective view of the support base of FIG. 6, on which is mounted the sheet-metal plate as seen in FIG. 4;

FIG. 8 is a perspective view of the mobile element of the steering column of FIG. 1, viewed from the side intended to face the sheet-metal plate;

FIG. 9 is a perspective view of the mobile element of FIG. 8, but viewed from the other side;

FIG. 10 is a side view of FIG. 6, but with the sheet-metal plate fixed to the support base and the mobile element positioned in collaboration with the sheet-metal plate;

FIGS. 11a to 11c depict a cross section in offset planes of FIG. 10, the offset planes being perpendicular to the axis of the steering column A and being indicated by the line CC′ in FIG. 10, in various positions of the steering column;

FIGS. 12a to 12c depict a cross section on DD′ in FIG. 10, in various positions of the steering column;

FIG. 13 depicts part of a steering column according to a second embodiment;

FIG. 14 is a perspective view of the support base according to a third embodiment;

FIGS. 15 and 16 are views of details of part of

FIG. 14, respectively in a face-on view and in a view in cross section on GG′;

FIG. 17 is a face-on view of the sheet-metal plate according to the third embodiment of the invention;

FIG. 18 is a view in cross section on a transverse plane containing the axis FF′ of FIG. 17;

FIG. 19 is a rear view of the sheet-metal plate of FIG. 17;

FIG. 20 is a perspective view of the mobile clamping element according to the third embodiment viewed from an opposite side to the face intended to face the sheet-metal plate of FIG. 17;

FIG. 21 is a view of the mobile element of FIG. 20 viewed from the other side, namely from the side intended to face the sheet-metal plate of FIG. 17;

FIG. 22 is a perspective view of the support base of FIG. 14 on which the sheet-metal plate of FIG. 17 is mounted.

### DETAILED DESCRIPTION OF EXEMPLARY EMBODIMENTS

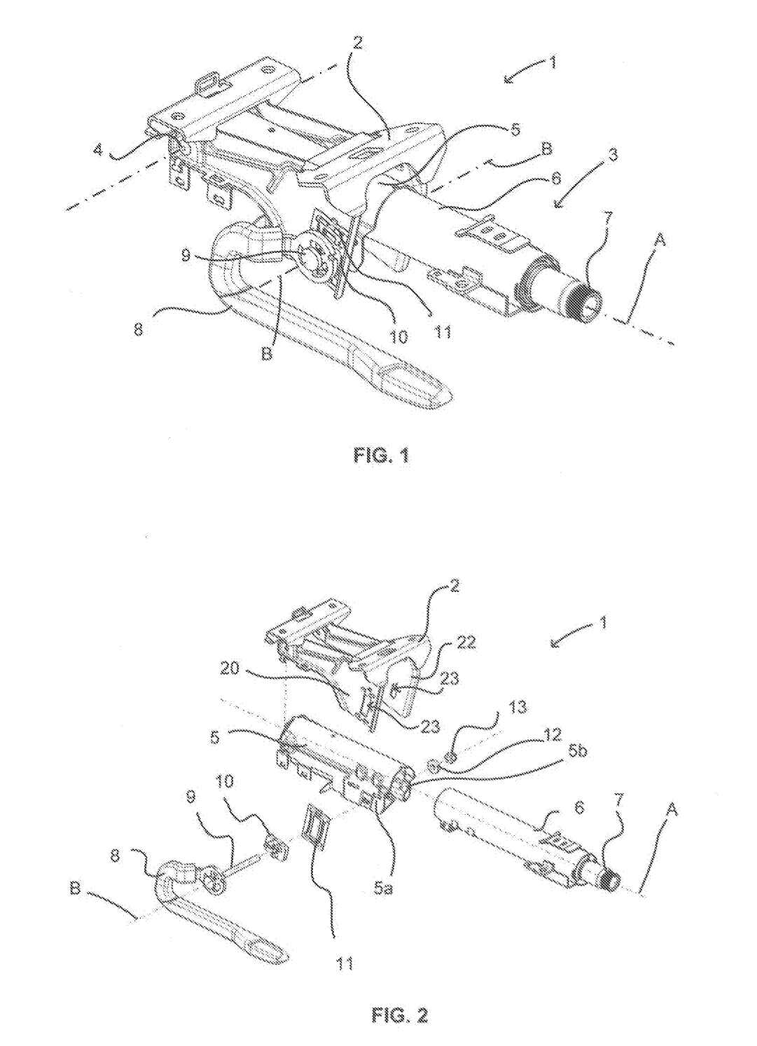

FIGS. 1 and 2 illustrate a steering column 1 for a motor vehicle according to some embodiments, incorporating a cover 2 forming a support base for a steering member 3.

The steering member 3 includes a tube, referred to as upper tube, connected to a steering wheel end piece 7, the latter being intended to be connected to the steering wheel (not depicted) of the vehicle. The steering wheel end piece 7 forms the end of a steering shaft free to rotate about an axis of rotation. This rotation allows the rotations of the steering wheel to be transmitted to the steering mechanisms (not depicted) which drive the orientation of the wheels of the vehicle. This axis of rotation is referred to as the steering column axis.

The upper tube 6 is mounted with the ability to slide in a lower body 5 along an axis of axial adjustment coaxial with the steering column axis. The reference A in the drawing refers interchangeably to these two axes. This sliding allows a first adjustment of the steering wheel for reach.

The lower body 5 is mounted with the ability to rotate about a pivot axis 4 borne by the cover 2. This is one exemplary embodiment that allows the steering member 3 to be articulated in rotation on the cover 2. This particular rotation allows radial adjustment of the steering wheel. The pivot axis 4 is intended to be horizontal when the steering column 1 is mounted in the vehicle.

A clamp is designed to allow the cover 2 and the steering member 3 to be clamped together and, in particular, to allow the cover 2, the lower body 5 and the upper tube 6 to be clamped together. That allows the assembly to be locked in a fixed position with respect to the chassis of the vehicle and therefore allows the steering wheel to be held in position when the vehicle is in use. The clamp is also designed to be able to unclamp, the cover 2 and the steering member 3 and, in particular, the cover 2, the lower body 5 and the upper tube 6 no longer being clamped together. The axial and/or radial adjustments of the steering wheel can then be made.

In the exemplary embodiment illustrated, the clamp includes a clamping lever 8, a clamping screw 9, a mobile element 10, a needle thrust bearing 12 and a clamping nut 13.

As can be seen in FIG. 2, the clamping screw 9 includes a longitudinal axis corresponding to the direction of clamping of the mobile element 10 against the cover 2 and therefore of the latter and of the steering member 3. This longitudinal axis is referred to hereinafter as the clamping axis B.

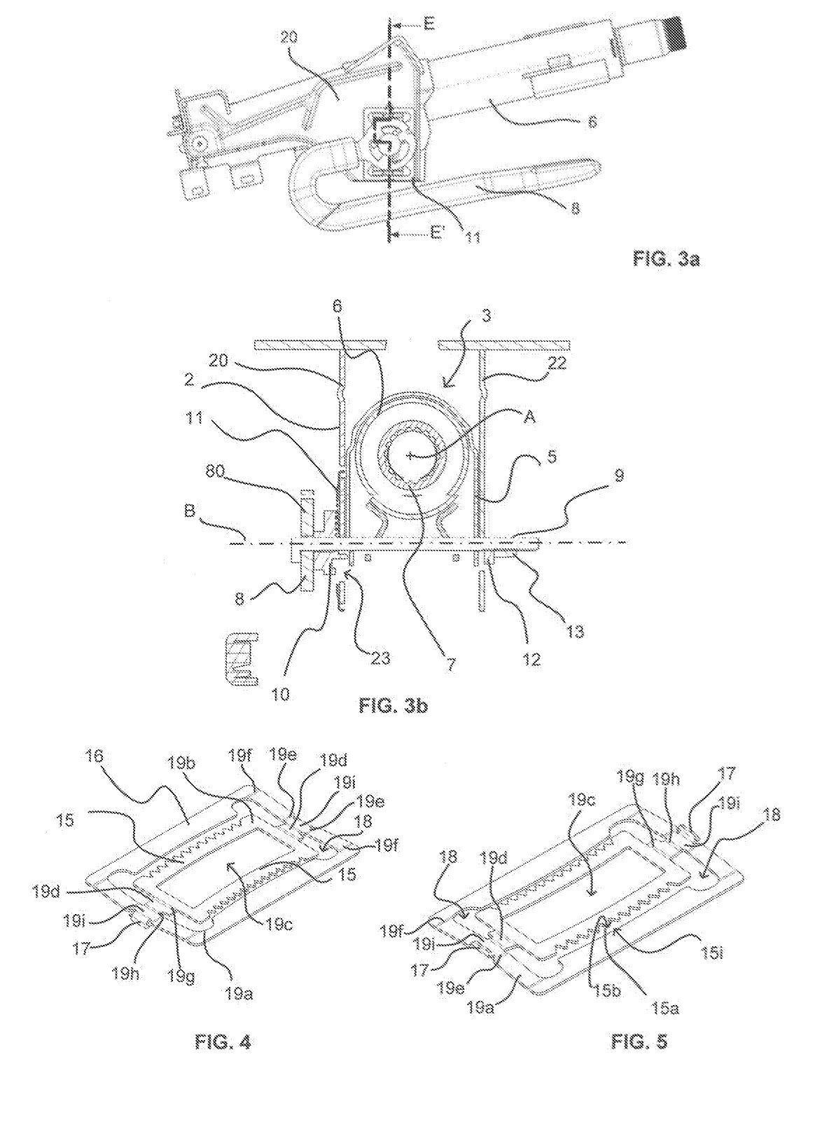

FIG. 3b is a cross section on offset planes which are perpendicular to the steering column axis A when the lever 8 is in the locked position. As illustrated in FIG. 3a, these planes follow the line EE′. Progressing down along this line EE′, from top to bottom, a first plane passes through the clamping axis B, a second plane passes through a row of teeth of the mobile element 10, and finally a third plane passes likewise along the clamping axis B. These teeth are visible in FIG. 3b and in greater detail in FIG. 8.

The clamping screw 9 is arranged through clamping orifices in the lower body 5, in which orifices it is free to rotate about the clamping axis B. Thus, this clamping screw 9 is borne by the steering member 3. The lower body 5 includes two flanks 5a, 5b one on each side and in contact with the upper tube 6. Each of these flanks is pierced to form one of the clamping orifices.

The cover 2 includes a first and a second clamping wall 20 and 22 arranged one on each side of the lower body 5 and facing the flanks 5a and 5b thereof. Each of these clamping walls 20, 22 includes a screw hole 23. The clamping screw 9 also passes through these screw holes 23, which are arranged in such a way that the clamping screw 9 can be mobile in rotation with respect to the cover 2 and secured to the lower body 5. These screw holes 23 may have a bowed shape, with edges corresponding to circles centred on the pivot axis 4. This is the case in the example illustrated, in which these holes form oblong holes 23. The clamping screw 9 can therefore move along these oblong holes 23, notably while maintaining the orientation of the clamping axis B, notably a horizontal orientation.

The ends of the clamping screw 9 protrude on each side of the cover 2. To a first end is fixed the lever 8, which can therefore turn the screw about the clamping axis B. A nut 13 is screwed onto the second end of the clamping screw 9 and with the second clamping wall 22 clamps in a vice-like grip a thrust bearing 12, notably a thrust needle bearing. As this thrust bearing 12 has a diameter greater than the clamping orifice of the second clamping wall 22, it forms a thrust bearing in relation to a translational movement of the clamping screw 9 along the clamping axis B.

Between the lever 8 and the first clamping wall 20, the mobile clamping element 10 is mounted on the clamping screw 9. The mobile clamping element 10 includes a central hole through which the adjusting screw passes so that the mobile element can slide along the clamping screw 9 and through this central hole.

According to the exemplary embodiment illustrated and notably according to FIGS. 2 and 9, the mobile clamping element is a cam 10 including ramps 81 collaborating with camways (not depicted) that are fixed with respect to the clamping screw. In this example, these camways are borne by one end 80 of the lever 8 in which end the first end of the adjusting screw 9 is fixed. Thus, according to the rotation of the lever 8 in the direction for locking or of unlocking, the camways force the cam 10 to move along the adjusting screw 9 respectively towards or away from the first clamping wall 20.

Actuation of the lever 8 in the locking direction therefore pushes on the cam 10 that comes into contact with a sheet-metal plate 11 fixed to the first clamping wall 20, hereinafter the blocking wall 20. The cam 10 therefore presses against this blocking wall 20. Thus, the cam 10 and the thrust bearing 12 clamp the clamping walls 20, 22 of the cover 2 in a vice-like grip and these themselves clamp in a vice-like grip the flanks 5a and 5b of the lower body 5 which themselves clamp in a vice-like grip the upper tube 6. The steering member 3 is thus blocked in a given position.

When the lever 8 is actuated in the unlocking direction, the camways no longer apply thrust to the cam 10, the stress on the clamping walls 20, 22 and the flanks 3a, 3b decreases, and the cam 10 moves away from the blocking wall. An elastic device, notably as will be described later on, makes it possible for the cam 10 to move away more easily. As a result, the upper tube 6, the lower body 5 and the cover 2 are no longer clamped together. It is then possible to adjust the steering wheel axially or radially about the pivot axis 4.

Alternatively, the movement of the mobile clamping element 10 in the two directions along the adjusting screw may be brought about by a needle, roller or ball system mounted between the lever and the mobile element and turned by the lever.

The clamping movement applies enough force to keep the steering member 3 in position during normal use of the vehicle. For example, this clamping allows the steering wheel to be kept blocked despite the application of a vertical force on the steering wheel of 200 to 1000 Newtons.

However, in the event of the vehicle being involved in a collision that causes the driver to be thrown against the steering wheel, this force will not be enough to prevent the steering member 3 from effecting a pivoting movement about the pivot axis 4.

The sheet-metal plate 11 and the mobile element, notably the cam 10, are designed to allow additional and stronger blocking in order to prevent any pivoting movement in the event of a collision.

The sheet-metal plate 11 is illustrated in greater detail in FIGS. 4 and 5. This plate 11 includes cuts and folds which form the various portions of this sheet-metal plate 11.

In this example, the sheet-metal plate includes two slots 18 cut into this plate and which divide it into two frames 19a and 19b connected by spacer pieces 19d formed as one with these frames. The first frame forms an outer frame 19a surrounding the second frame referred to as the central frame 19b.

The central frame 19b includes a central opening 19c facing the oblong hole 23 in the blocking wall 20.

The central frame 19b has two members between which the adjusting screw 9 can slide as the steering member 3 pivots about the pivot axis 4. The edges of these members are cut to form teeth 15a, each toothed member forming a rack 15.

Each of the racks 15 therefore forms a metal leaf.

According to one embodiment, and as in the example illustrated, as the teeth 15a are formed in the sheet-metal plate 11, these teeth 15a point transversely. In other words, one of the end faces 15b of each tooth 15 faces the blocking wall 20.

According to one embodiment of the invention, the spacer pieces 19d and the outer frame 19a have an arrangement, notably bends or curvatures, that is such that part of the outer frame 19a and the central frame 19b are offset relative to at least a given portion of the outer frame along the clamping axis B when the steering column 1 is in the unlocking position. This given portion is preferably or possibly mounted in contact with the blocking wall 20 and referred to hereinafter as the bearing portion 19i.

According to one embodiment of the invention, the outer frame 19a has bends 19e and 19f, just as the central frame 19b has bends 19g and 19h. These bends are arranged in such a way as to allow the offsetting described in the preceding paragraph.

The outer frame 19a may, as illustrated, exhibit two bearing portions 19i which are joined directly to the spacer pieces 19d.

The latter for example include two bends 19g and 19h allowing the central frame 19b to be offset with respect to the two bearing portions 19i.

The outer frame 19a includes lateral members 16. This outer frame 19a may also, as in this example, exhibit two bends 19e and 19f between these lateral members 16 and the bearing portions 19i, namely eight bends 19e, 19f in this example. These bends allow the lateral members 16 to be offset with respect to the two bearing portions 19i. This offsetting gives the sheet-metal plate elastic properties by forming two spring leaves corresponding to those portions of the outer frame 19a that are situated on either side of the spacer pieces 19i.

The offset and, for example, the bends, may be arranged in such a way that when the steering column 1 is in the unlocking position and along the clamping axis B, the lateral members 16 of the outer frame 19a are closer to the cam 10, the bearing portion 19i is closer to the blocking wall 20, and the central frame 19b is between the lateral members 16 and the bearing portion 19i. Thus, in FIG. 5, in which the side of the sheet-metal plate 11 that is intended to face the blocking wall 20 can be seen, the bearing portions 19i are forward of the central frame 19b and the outer frame 19a is set back from the central frame 19b.

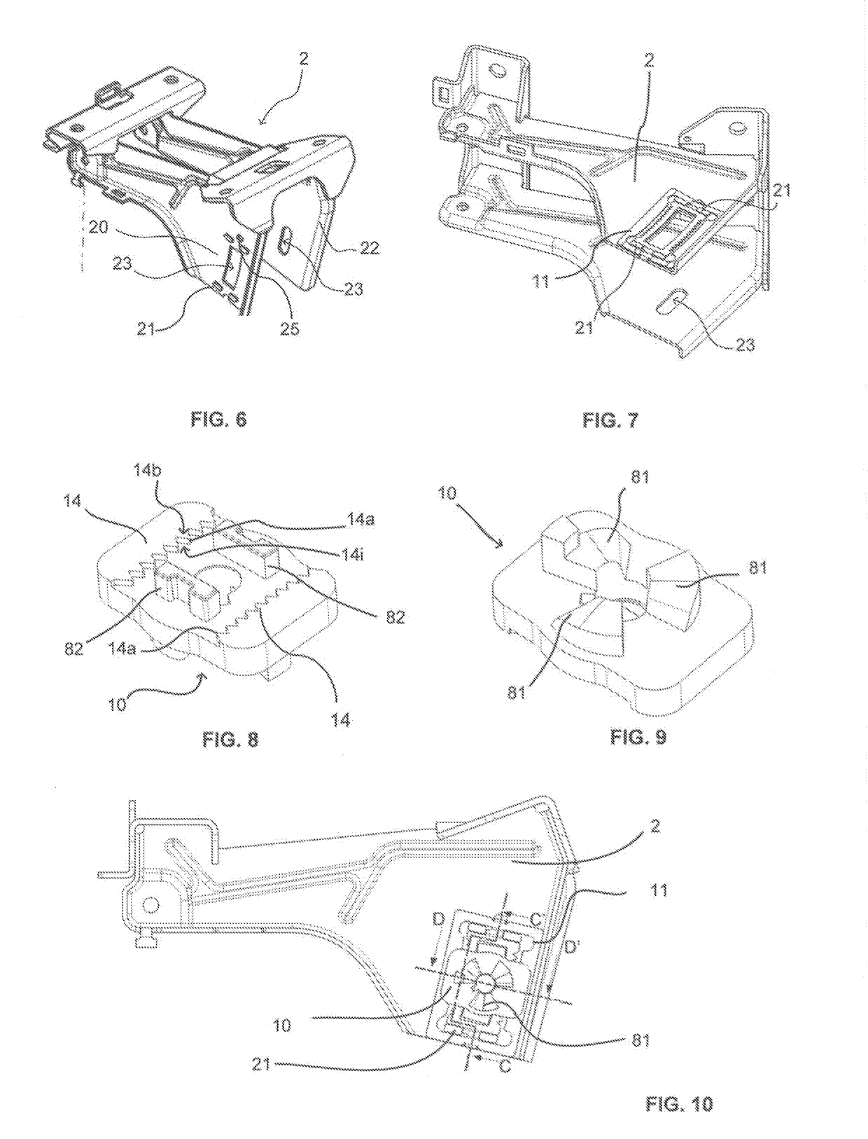

As illustrated in FIG. 6, the blocking wall 20 of the cover 2 includes fixing holes 25, notably one above the oblong hole 23 and one below. The sheet-metal plate 11 includes two fixing tabs 17 fixed by elastic fitting or clip-fastening into these fixing holes 25 as can be seen in FIG. 7. The adjusting screw 9 therefore passes through this central opening 19c and the oblong holes 23 once the steering column 1 has been assembled, as in FIG. 1.

As can be seen in FIGS. 4 and 5, the central opening 19c may have slightly curved edges. These curvatures may correspond to an arc of a circle centred on the pivot axis 4 and perpendicular to this pivot axis 4. The opening 19c may thus have a width close to the diameter of the clamping screw 9, while allowing the clamping screw 9 to move inside this central opening 19c during vertical adjustment of the steering wheel, notably while maintaining the orientation of the clamping axis B.

This blocking wall 20 may also include at least one stud 21 between the central frame 19b and the outer frame 19a. When there are several studs 21, these may be arranged on either side of the central frame 19b. This or these studs 21 act as end stops for the central frame, and therefore for the racks 15. According to one exemplary embodiment which is more effective at acting as an end stop for the central frame 19b, these studs 21 are distributed about the central frame 19b. For example, these studs 21 are four in number, notably two above and two below this central frame. The layout of this or these studs contributes to the blocking of the central frame 19b, this blocking preventing the steering member 3 from rotating about the pivot axis 4.

These studs 21 may be produced in various ways: pressed or bent form, in a form partially cut out from the metal sheet, or alternatively in the form of elements added and attached to the cover 2.

In the example illustrated in FIGS. 8 and 9, the cam 10 includes a face bearing the ramps 81 and an opposite face including two toothed interfaces 14, each one forming a row of teeth 14a. The end faces 14b of the teeth 14a may face the sheet-metal plate. Each of these toothed interfaces 14 is designed to be able to engage in the racks 15 of the sheet-metal plate 11.

In the example illustrated, the tips of the teeth 14a of one of the toothed interfaces 14 face towards the tips of the teeth 14a of the other of the toothed interfaces 14. The distance between the two toothed interfaces 14 is designed so that the central frame 19b can become lodged between the toothed interfaces 14, the teeth 14a of the toothed interface becoming lodged between the teeth 15a of the racks 15.

That face of the cam that bears the toothed interfaces 14 may also bear projections extending out from these faces and forming slides 82, notably on each side of the central hole through which the adjusting screw 9 passes.

These slides 82 are designed with a width that allows them to slide between the edges of the central opening 19c of the sheet-metal plate 11 once the cam 10 is mounted against the sheet-metal plate 11 as can be seen in FIG. 10. Thus, during adjustment, these slides 82 will not impede the movement of the adjusting screw 9 during radial adjustment of the steering wheel. In addition, because these slides 82 are, adopting as reference the face of the cam 10 that carries them, higher than the toothed interfaces 14, they are able to slide in the central opening 19c of the sheet-metal plate 11, providing guidance for the mobile element 10 along the clamping axis B. This makes it easier for the toothed interfaces 14 and the racks 15 to mesh with each other.

The operation of the steering column according to this first embodiment will now be detailed.

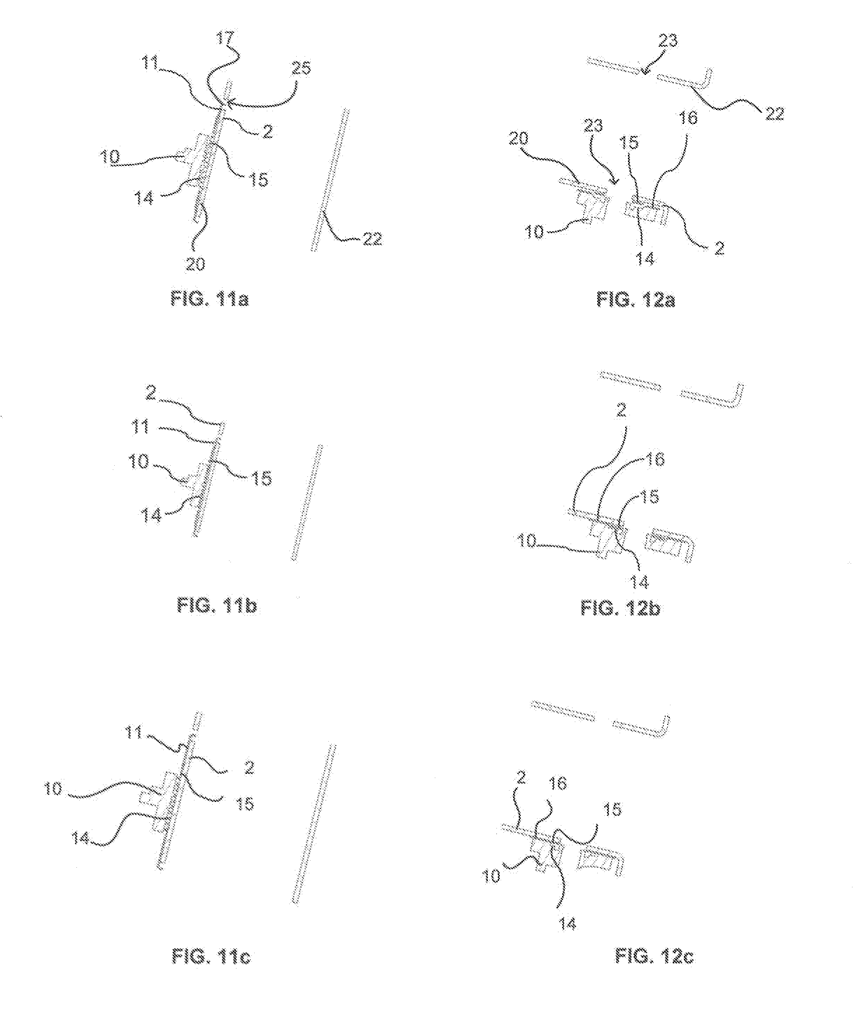

FIGS. 11a to 11c are cross sections on offset planes perpendicular to the steering column axis, in different positions of the clamping lever. As illustrated in FIG. 10, these planes follow the line CC′. Progressing down along this line CC′, from top to bottom, a first plane passes through the clamping axis B, a second plane passes through a row of teeth of the mobile element 10, and finally a third plane passes once again through the clamping axis B.

In the unlocked state illustrated in FIGS. 11a and 12a, the teeth 14a of the cam 10 are offset towards the lever 8 with respect to the teeth 15a of the rack 15. Thus, the teeth of the racks 15 and of the toothed interfaces 14 are disengaged. In addition, the clamp is no longer clamping the steering member 3 and the cover 2 together. It is therefore possible to perform vertical adjustment of the steering wheel.

Because of the bends 19g and 19h, the racks 15 are some distance away from the blocking wall 20.

Once the adjustment has been made, locking the clamp using the lever 8 allows the steering wheel to be fixed in a position chosen by the driver. Thus, during everyday use of the vehicle, the clamps locked with significant tension in the clamping screw 9 and all the components of the clamp are in contact. In the example illustrated, the toothed interfaces 14 push the lateral members 16 against the blocking wall 20. The clamping load is thus transmitted to the walls of the cover 2, which clamp the lower body 5.

This locking action also allows the cam 10 to reengage in the sheet-metal plate 11, as illustrated in FIGS. 11b and 12b. The toothed interfaces 14 of the cam 10 are therefore engaged in the racks 15 of the sheet-metal plate 11.

The teeth 14a of the toothed interface 14 and the teeth 15a of the rack 15 form first and second blocking shapes which, by virtue of their arrangement and of this engagement, prevent the steering member 3 from rotating about the pivot axis 4.

Specifically, in a collision, with the steering wheel being forced downwards, the radial load transmitted from the steering wheel has a tendency to cause the lower body 5 to pivot about the pivot axis 4. This lower body 5 carries with it the clamping screw 9 which drives the cam 10. The latter is therefore blocked by the sheet-metal plate 11, thanks to the intermeshing of the teeth 14a and 15a. The sheet-metal plate 11 is itself blocked by the cover 2, to which it is fixed, the cover being fixed to the chassis.

The studs 21 contribute to this blocking load. This also relieves the load on the fixing tabs 17.

For example, a steering column 1 according to the invention, by virtue of this sheet-metal plate 11, is able to withstand a load higher than the clamping load. For example, the sheet-metal plate 11 allows the steering wheel to be kept blocked despite the application of a vertical force of 5000 Newtons on the steering wheel.

During locking, it is possible for the teeth of the toothed interfaces 14 and those of the racks 15 to be offset and, instead of intermeshing, come and press end face against end face, in what is referred to as a tooth-on-tooth position illustrated in FIGS. 11c and 12c. As a result, and as can be seen more specifically in FIG. 11c, the teeth 14a of the cam 10 push the racks 15, which therefore move closer to the blocking wall 20. The toothed interfaces 14 also push the lateral members 16 against the blocking wall 20. The clamping load is thus transmitted to the walls of the cover 2, which clamps the lower body 5. The steering column 1 according to some embodiments is therefore locked, even in a tooth-on-tooth position.

In addition, the movement of the racks 15 closer to the blocking wall 20 reduces the offset between these racks and the bearing portions 19i. This then results in elastic deformation of the spacer pieces 19d. As a result of this elastic deformation, the impact on the load felt at the lever 8 is very small.

When the vehicle is involved in a collision, the radial load causes the cam 10 to slide on the plate 11 until the teeth mesh because of the stiffness of the metal sheet of which the sheet-metal plate 11 is made. In this example, the elastic deformation places the assembly formed by the spacer pieces 19d and the racks 15 under strain; as a result, the assembly formed by the spacer pieces 19d and the racks exerts a return force encouraging the intermeshing of the teeth 14a and 15a. The steering column 1 returns to the configuration illustrated in FIGS. 11b and 12b with the radial movement of the steering wheel blocked.

According to one embodiment of the invention, the teeth 14a of each toothed interface 14 are separated by gaps 14i and have a width smaller than the width of these gaps. Likewise, the teeth 15a of each rack 15 are separated by gaps 15i and have a width smaller than the width of these gaps. That allows for a slight clearance between the teeth 14a of the toothed interfaces 14 and the teeth 15a of the racks 15 as these toothed interfaces 14 and these racks 15 engage. Tooth engagement thus becomes easier particularly in the event of collision, when the cam 10 and the sheet-metal plate 11 move from a tooth-on-tooth position into an intermeshing position.

During normal use, in order to make a further adjustment, actuating the lever 8 in the unlocking direction makes it possible to cancel the tension in the adjusting screw 9, to release the cam 10 which moves along the clamping axis B towards the clamping lever 8. This movement may be brought about or facilitated by an elastic disengagement device designed to push the cam 10 back. This movement therefore allows the teeth of the toothed interfaces 14 and of the racks 15 to be disengaged.

According to the first embodiment, the elastic device is one or more spring leaves at the periphery of the sheet-metal plate 11 and borne thereby. As in this example, these spring leaves are formed by the outer frame, particularly by virtue of the bends between the lateral members 16 and the bearing portion 19i. This elasticity is conferred by the stiffness of the sheet metal of which the sheet-metal plate 11 is made and by the fact that, as explained earlier, the outer frame 19a is offset with respect to the bearing portion 19i. The more this offset decreases, the more the elastic strain increases.

This offset can be seen more particularly in FIG. 12a which shows these lateral members 16 more offset along the clamping axis B towards the cam 10 than the racks 15. During locking, the cam 10 comes into contact first of all with these lateral members 16 and places them under elastic strain.

This offset then decreases. It may go so far as to cancel out as in the tooth-on-tooth position (FIG. 12c) and invert when the teeth are in the engaged position (FIG. 12b). This application of strain will later allow the cam 10 to disengage.

According to one embodiment of the invention, in the unlocked state, the sheet-metal plate 11 can be mounted under preload, so that the lateral members 16 are in contact with the toothed interfaces 14 as can be seen in FIG. 12a. This strain then increases during locking.

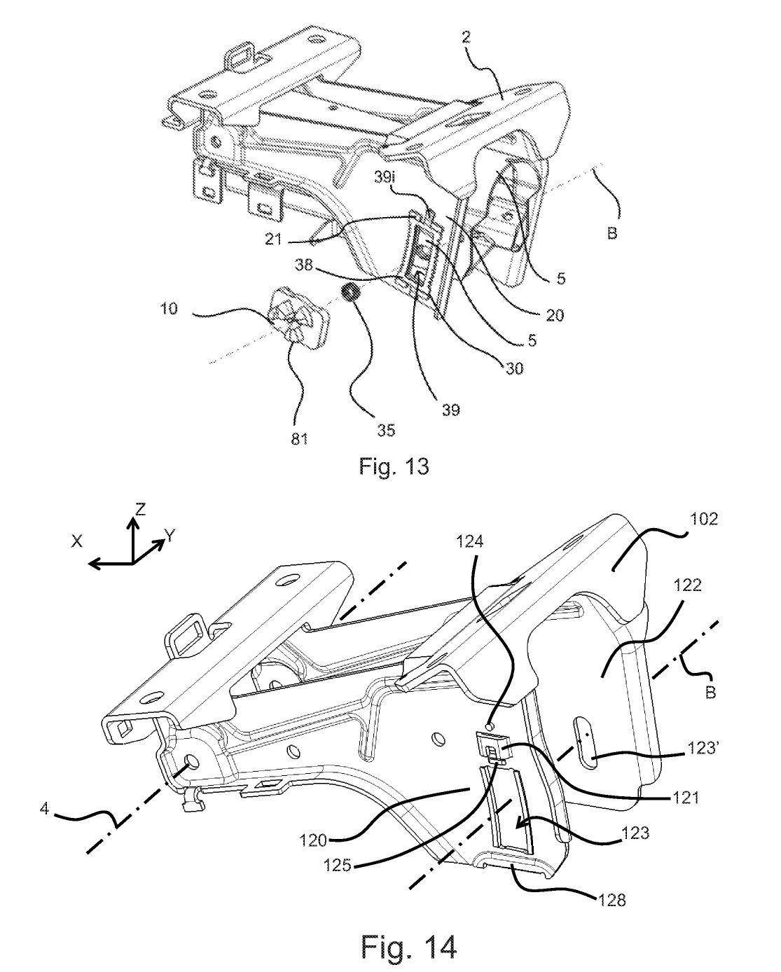

According to a second embodiment illustrated in FIG. 13, the steering column differs in terms of the sheet-metal plate 30 used and in terms of the disengagement elastic device.

This sheet-metal plate 30 includes just one single frame 38 with a central opening 39. This frame 38 may have the same features as the central frame 19b of the sheet-metal plate 11 of the first embodiment. It collaborates in the same way with the cam 10 which may have the same features as in the first embodiment, apart from the presence of the contact portions described hereinafter.

Likewise, the same cover 2 from the first embodiment can be used. In particular, the single frame 38 can be housed between the studs 21.

The disengagement elastic device is itself formed of at least one spring 35 which is mounted between the lower body 5 and the cam 10 which pushes this cam 10 back and disengages it from the sheet-metal plate 30 during unlocking.

It is possible to have just one spring 35 as in the example illustrated. The spring 35 may for example be a coil spring wound onto the clamping screw 9, in contact on one side with the cam 10 and on the other with the lower body 5, passing through the central opening 39 of the frame 38 and through the oblong hole 23 in the blocking wall 20.

It is also possible to arrange two springs one on each side of the adjusting screw 9. These springs may likewise be coil springs.

In this example, the racks 15 are cut from the thickness of the metal sheet of the plate, and also have two bends both situated between the frame 38 and a bearing zone 39i intended to press against the blocking wall 20. This thickness and these bends give the frame 38 spring properties. That, as in the first embodiment, allows the application of a return force encouraging the intermeshing of the teeth of the sheet-metal plate 30 and of the teeth of the cam 10, in the event of an impact while the steering column is in the tooth-on-tooth position. It also makes it possible to minimize or reduce the travel needed to disengage the cam 10.

It should be noted that, in this second embodiment, the toothed interfaces differ from the toothed interfaces 14 depicted in FIG. 8 in that they include contact portions (not depicted) facing the blocking wall 20. These contact portions are arranged so that they are offset towards the blocking wall 20 with respect to the teeth 14a of the cam 10 in such a way that during locking, these contact portions press directly against the blocking wall 20, thus transferring the clamping load to the blocking wall 20.

In the first embodiment, the vertical rack 11 incorporates, with no additional component, the function of disengaging the cam 10.

The second embodiment makes it possible to reduce the size of the blocking system in the event of a collision, thanks to a reduced-area racks assembly.

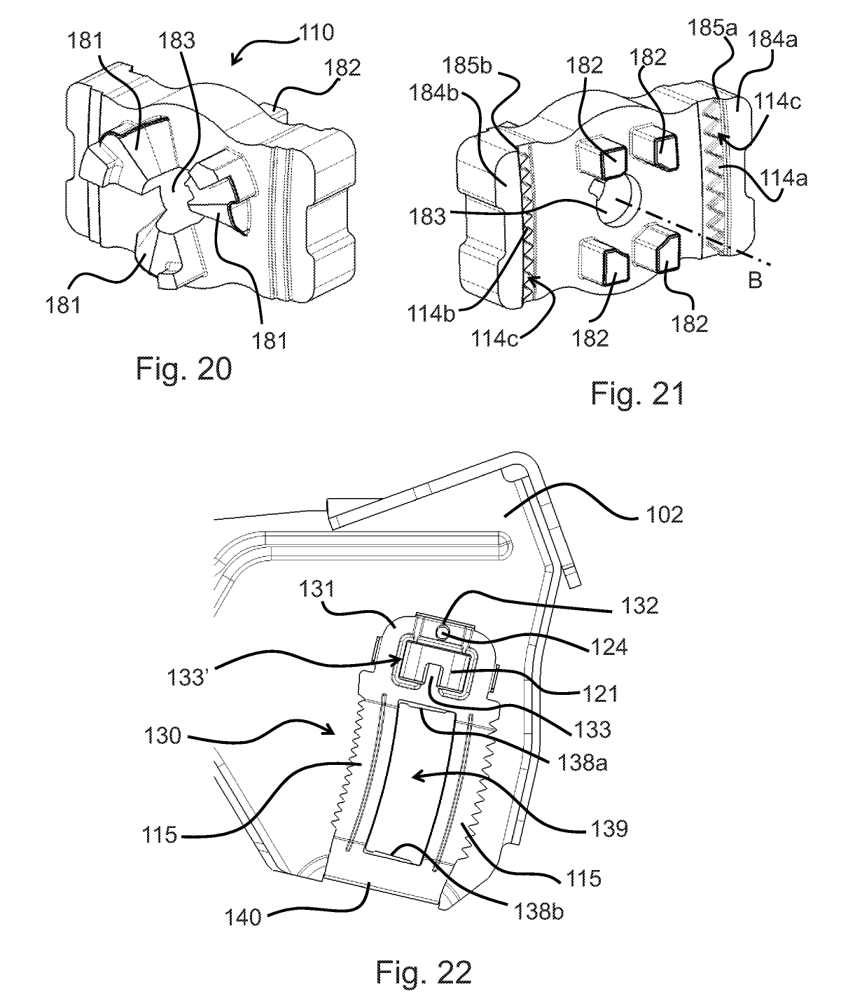

FIGS. 14 to 22 illustrate a third embodiment. In FIGS. 14, 15 and 16, only the cover 102 has been depicted. In this third embodiment, the cover 102 differs from the cover 2 of the second embodiment in terms of the region over which the sheet-metal plate is intended to be received and also differs in terms of this sheet-metal plate itself.

Hereinafter, unless specified otherwise, the terms above, below, longitudinal, transverse, vertical, lower and upper are defined with respect to the orientation that the steering column is intended to adopt once it has been mounted in the vehicle. The longitudinal, transverse and vertical axes (X), (Y) and (Z) respectively may therefore correspond to those of a vehicle intended to accept the steering column.

This cover 102 therefore includes, like that of the second embodiment, clamping walls 120 and 122 which tighten against each side of the lower body, not depicted, to block the latter or to unblock it to allow the lower body and the tube to rotate about the pivot axis 4 of the steering column.

The lower body, the tube and the clamping screw may be identical to those of the second embodiment. Only the clamping axis B is depicted in FIG. 14.

The clamping walls 120, 122 likewise include a first and a second oblong hole 123 and 123′, having a bowed shape centred on the pivot axis 4, to accept the clamping screw and allow it to move along these oblong holes 123, 123′ during heightwise rake adjustment of the steering column.

As can be seen in FIG. 22, one of the clamping walls, in this instance the one on the side of the clamping lever (not depicted in FIGS. 14 and 22), forms the blocking wall 120 which accepts the sheet-metal plate 130 illustrated separately in FIGS. 17 to 19 (and not depicted in FIGS. 14, 15 and 16).

This blocking wall 120 differs from that of the other embodiments in terms of the device(s) formed thereon to allow for the attachment of the sheet-metal plate 130, namely:
a lower edge of the blocking wall 120 having an insertion portion 128,
an arch 121 arranged on the other side of the first oblong hole 123, namely above the latter, and extending transversely and towards the outside of the cover 102,
a peg 124, in this instance circular, above the arch 121.

The sheet-metal plate 130 is designed to be able to slide from the bottom and along the blocking wall 120 and to plug into this wall at various points, as will be explained later on in support of some exemplary embodiments.

According to this third embodiment, steps 127a, 127b, extending vertically overall, may be formed along the edges of the first oblong hole 123.

In this instance, these steps 127a, 127b extend along the first oblong hole 123. In this instance, these steps are therefore bowed, their longest edges potentially being defined by circles centred on the pivot axis 4.

Between the arch 121 and the first oblong hole 123 may be arranged a protrusion 125 which in this instance takes the form of a rod that is transverse with respect to the clamping axis B. It may notably be obtained by pressing.

The insertion portion 128 may also be pressed to form a shoulder between this insertion portion 128 and the rest of the blocking wall 120.

As in the second embodiment, the sheet-metal plate 130 includes a single frame 138 formed by lower 138b and upper 138a members connected by racks 115 about a central opening 139.

The sheet-metal plate 130 includes a bow 131 arranged above the upper member 138a, extending overall in the one same plane and adjacent to this member. This bow 131 therefore defines, between its edges and the upper member 138a, a slot 133′.

The sheet-metal plate 130 also includes a bar 133 arranged predominantly in the overall plane of this sheet-metal plate and extending from the upper member 138a upwards. This bar 133 may, as here, have a distal end 134a at the opposite end from the upper member 138a and bent over slightly towards the blocking wall 120 when the sheet-metal plate 130 is mounted against this blocking wall 120.

The lower member 138b of the single frame 138 includes a curved edge 140, for example a bent-over edge, notably in the form of three bends so that it forms a vertical portion 144, a horizontal portion 141, a second vertical portion 142, and an oblique end portion 143 diverging from the sheet-metal plate 130.

The bow 131 may, as illustrated, at its top have a longitudinal indexing hole 132 which, in this example, is oblong.

When the sheet-metal plate 130 is mounted on the blocking wall 120, the sheet-metal plate 130 is positioned with the distal end 134 of the bar 133 above the protuberance 125, then the plate is slid upwards along the blocking wall 120.

The insertion portion 128 therefore slides against the oblique end portion 143 and then plugs into the curved edge 140 until it comes into contact with the horizontal portion 141 thereof.

At the same time, the distal end 134 passes under the arch 121, carrying a portion of the bar 133 under this arch 121. The arch 121 thus becomes lodged in the slot 133′ of the bow 131. The longitudinal indexing hole 132 then becomes housed around the peg 124.

FIG. 22 depicts the sheet-metal plate 130 once it has been mounted on the blocking wall 120.

To make it easier for the bar 133 to pass under the arch 121, the latter may include a notch 126 extending at the top of this arch 121 and opening downwards.

As in the previous embodiments, the teeth 115a and 115b of the rack may, as illustrated, have end faces 115c facing towards the blocking wall 120, namely transversely with respect to the clamping axis B. The teeth 115a, 115b of each rack 115 point in an opposite direction to the other of the racks 115, in other words point towards the outside of the sheet-metal plate 130.

These racks 115, thanks to the layout of the sheet-metal plate 130, form spring elements contributing to a return force in the event of tooth-to-tooth engagement with the cam 110 illustrated in FIGS. 20 and 21.

One exemplary embodiment that allows the racks 115 to flex towards the blocking wall 120, and therefore allows them to act as two spring leaves, is described hereinafter.

The protuberance 125 and the shoulder 129 are arranged in such a way that the protuberance 125 and the insertion portion 128 have bearing surfaces that are offset with respect to the rest of the blocking wall 120 in a direction parallel to the clamping axis B and away from the blocking wall 120. For example, this offset d, d′ may, for the protuberance 125 and/or the insertion portion 128, be 1 mm.

Once the sheet-metal plate 130 is mounted on the blocking wall 120, the upper member 138a of the single frame 138 is pressed firmly against the bearing surface 125′ of the protuberance 125, and the lower member 138b of this frame is pressed firmly against the bearing surface 128′ of the insertion portion 128.

Thus, the racks 115, when the column is unclamped, are some distance away from the blocking wall 120.

In the event of tooth-to-tooth blocking, the teeth 114a and 114b of the cam 110 push the teeth 115a, 115b of the racks, and therefore the latter, towards the blocking wall 120. This flexing makes it possible to generate a return force returning the racks 115 towards the cam 110 and therefore generating reengagement in the event of an impact.

According to an alternative form that has not been depicted, it is possible to leave the racks 115 to flex completely as far as the blocking wall 120.

According to the third embodiment, notably as illustrated, the steps 127a and 127b are arranged in such a way as to limit the flexing in the middle of the racks 115. The travel of the racks 115 is thus limited, thus reducing the risk of the teeth becoming disengaged in the event of an impact.

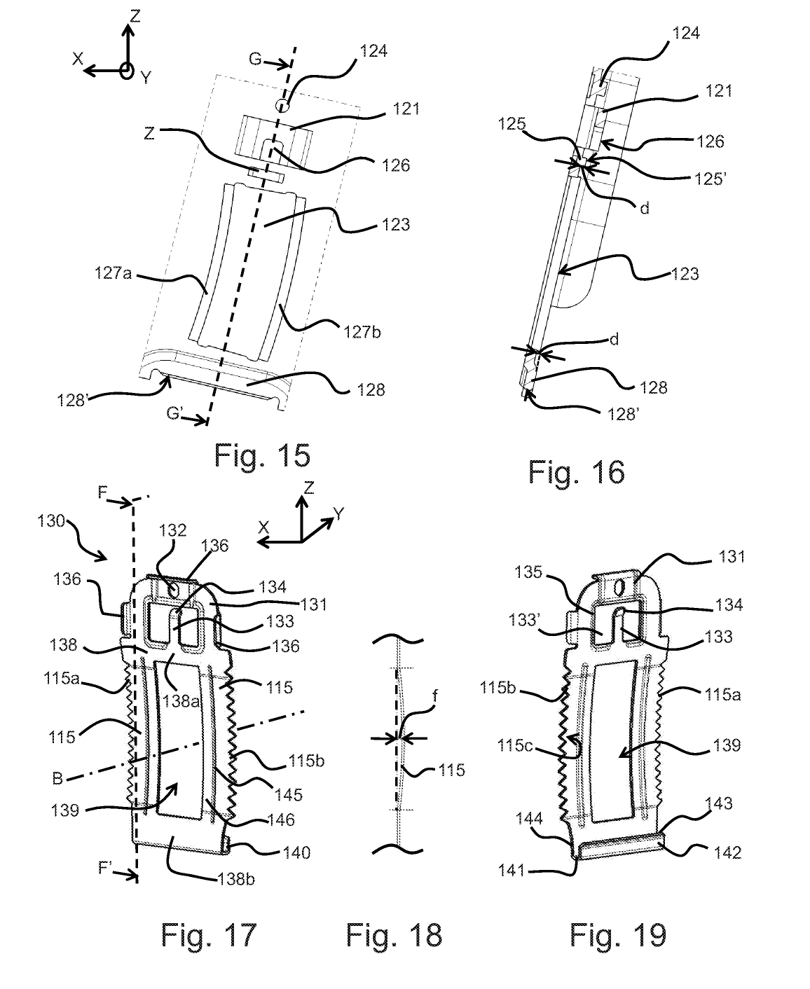

For example, the steps 127a and 127b of the blocking wall 120 may be transversely offset by 0.7 mm, namely towards the viewer of FIGS. 14 and 15.

The sheet-metal plate 130 may have a thickness of between 0.5 and 1 mm, for example of 0.6 mm.

In order to increase the stiffness of the sheet-metal plate 130, the latter may include ribs 145 situated on each side of the central opening 139 in a longitudinal direction.

For example, when the sheet-metal plate 130 is mounted on the cover 120, the steps 127a and 127b may be housed on a host surface 146 situated between the lateral edges of the central opening 139 and the ribs 145.

FIG. 18 illustrates a cross section on FF′ in FIG. 17, showing the rack 115 in profile. This rack is slightly curved, as can be seen in FIG. 18 which shows a discrepancy f between the theoretical straight line (in dotted line in FIG. 18) and the actual shape of the rack when unstrained. This discrepancy f allows the rack 115 to be offset slightly towards the cam 110.

Once manufactured, the sheet-metal plate may exhibit small faults. In addition, upon fitting, the plate may bend slightly. If, in such circumstances, the plate is bent towards the blocking wall, the teeth 114a, 114b of the cam 110 will be able to engage partially with the teeth 115a, 115b of the corresponding rack 115.

The discrepancy f resulting from the curved shape makes it possible to provide a tolerance between the theoretical straight line and this curved shape. Even if, as a result of its manufacture or mounting, the rack 115 is brought close to the blocking wall 120, it should not become bent in the other direction, thus reducing the risks of poor meshing.

In order to strengthen the fixing of the sheet-metal plate 130 each of the members of the bow 131 may have reinforcing flanges 136, in this instance formed by bent-over edges of the sheet-metal plate 130. These edges are bent over transversely and away from the blocking wall 120. The bow 131 is thus stronger.

Also, as can be seen in these figures, the bow 131 may be pressed at the edges of its slot 133′, in order to strengthen it further.

According to this embodiment, as illustrated here, the arch 121 may have a width substantially equal to that of the slot 133′ of the bow 131. Thus, in the event of impact, upward or downward rotational load is reacted between the upper and lower edges of the arch 121 and the bow 131, notably its edges around the slot 133′.

Upward rotational load is also reacted between the horizontal portion 141 of the curved edge 140 and the insertion portion 128.

The circular peg 124 for example allows longitudinal lateral indexing in collaboration with the longitudinal indexing hole 132, the latter having a width substantially equal to the diameter of the peg 124, there nevertheless being a clearance that allows the one to be housed in the other.

The indexing hole 132 may be oblong with its length arranged vertically to allow for a manufacturing tolerance. Vertical indexing may therefore be done by the horizontal portion 141 of the curved edge 140.

The cam 110, visible in FIGS. 20 and 21, may be identical to that of the third embodiment.

It includes a through-hole 183 intended to have the clamping screw passing through it. The cam 110 is arranged such that the end faces 114c of its teeth 114a and 114b are oriented toward the blocking wall 120 and therefore towards the sheet-metal plate 130.

The separation between the rows of teeth 114a and 114b is designed so that these can come on each side of the sheet-metal plate 130 to mesh longitudinally with the teeth 115a, 115b of the latter.

On the opposite side to the face intended to face the blocking wall 120, the cam 110 includes camways 181 which collaborate with the cams driven by the lever to move the cam 110 towards or away from the blocking wall 120.

As in the second embodiment, one or two springs may be arranged between the cam 110 and the blocking wall 120 or between the cam and the lower body, so as to move the cam 110 away when the steering column is unclamped.

The cam 110 may also include slides 182 distributed about the through-hole 183 for the passage of the screw and arranged in such a way as to be able to slide against the edges of the central opening 139 of the sheet-metal plate 130. That allows guidance of the cam 110 as the clamping screw moves through the central opening 139. This then improves the meshing of the cam 110 with the sheet-metal plate 130, once the adjustment has been made.

The slides 182 may have vertical external faces, namely the faces facing the teeth 114a, 114b of the cam 110. These faces are bowed in the same way as the edges of the central opening 139 against which these faces slide. This improves guidance.

As in the second embodiment, this cam 110 includes contact portions 184a, 184b, arranged on each side of the rows of teeth 114a and 114b of the cam 110.

As in the second embodiment, these contact portions 184a, 184b are:
facing the blocking wall 120, and
offset relative to the teeth 114a, 114b of the cam 110 in the direction of the blocking wall 120,
   so that, during locking, these contact portions 184a and 184b press directly against the blocking wall 120, thus transferring the clamping load to the blocking wall 120, even in the event of tooth-on-tooth positioning.

For that, the cam 110 may include shoulders 185a, 185b.

According to some embodiments, and notably in this example, the racks 115 may become lodged in a space formed between these contact portions 184a, 184b and the clamping screw.

In general, the arrangement of tooth end faces of the sheet-metal plate 11, 30, 130, allowing reduced movement compared with teeth perpendicular to the blocking wall 20, 120, is an arrangement that also makes it possible to have camways 81, 181 with a height, considered from their base towards the lever in the direction of the clamping axis B, that is shorter than with teeth perpendicular to the blocking wall 20, 120. As a result, this allows end face teeth to be used to improve the effectiveness of the clamping system. In addition, the user feels a more pronounced locking when placing the lever in the locking position.

Other alternative forms of embodiment which have not been illustrated, which notably apply to the two embodiments, may also be envisaged and in which:
the steering column may include two sheet-metal plates installed one on each side of the steering column, on each clamping wall 20, 22;
instead of studs 21, the cover may include holes and the rack may include complementary shapes that fit into these holes;
the teeth of the vertical rack may be parallel to the clamping axis B;
the teeth of the sheet-metal plate may be at the periphery of the sheet-metal plate and the spring leaves for disengaging the cam in the middle of the sheet-metal plate; for example, it is the members of the outer frame that bear the racks and the central frame that bears the spring leaves.

1. A steering column for use with a vehicle steering wheel and a vehicle chassis, the steering column comprising:
a steering member configured to be connected to the vehicle steering wheel,
a support base, configured to be mounted fixedly with respect to the vehicle chassis, the steering member being mounted articulated in rotation to the support base,
a clamp borne by the steering member and including a mobile clamping element, the clamp being arranged so as to be able to lock the steering member on the support base by clamping of the mobile element against the support base,
first blocking shapes borne by the mobile clamping element, and
second blocking shapes borne by a sheet-metal plate that is blocked against the support base,
wherein the steering column is configured such that the first blocking shapes are able, during locking of the steering member on the support base by clamping of the mobile element against the support base, to engage between the second blocking shapes so as to block the rotation of the steering member with respect to the support base.

2. The steering column according to claim 1, wherein the first blocking shapes and the second blocking shapes are teeth.

3. The steering column according to claim 2, wherein the teeth have end faces arranged facing the blocking wall.

4. The steering column according to claim 3, wherein:
the teeth borne by the sheet-metal plate point towards the outside of the sheet-metal plate, and/or
the teeth borne by the mobile clamping element point towards a midplane of this mobile clamping element.

5. The steering column according to claim 1, wherein the sheet-metal plate is made of a cut metal sheet, the second blocking shapes being obtained by cutting.

6. The steering column according to claim 1, wherein the clamp includes a clamping screw arranged in such a way as to be able to drive the mobile clamping element into a locking position in which the mobile clamping element is clamped against the sheet-metal plate and to be able to move the mobile clamping element away from the sheet-metal plate towards an unlocking position.

7. The steering column according to claim 1, wherein the support base includes a blocking wall against which the sheet-metal plate is blocked, and the sheet-metal plate includes elastic portions some distance away from the blocking wall and distinct from the second blocking shapes, the elastic portions and the mobile clamping element being arranged in such a way that when the mobile clamping element is clamped against the sheet-metal plate, it moves the elastic portions against this blocking wall, thus placing these elastic portions under elastic strain.

8. The steering column according to claim 7, wherein the sheet-metal plate includes slots delimiting, with the edges of the sheet-metal plate, metal strips that form the elastic portions.

9. The steering column according to claim 1, further comprising an elastic element mounted between the mobile clamping element and the steering member and arranged in such a way that its strain increases as the mobile clamping element is clamped against the sheet-metal plate.

10. The steering column according to claim 1, wherein the support base includes a blocking wall against which the sheet-metal plate is blocked, and the sheet-metal plate includes at least one portion forming a metal leaf which bears all or some of the complementary second shapes, the metal leaf being arranged in such a way that when the mobile clamping element is some distance away from the sheet-metal plate, the metal leaf is some distance away from the blocking wall, so that if, during clamping, the first blocking shapes come to press on the second blocking shapes, the metal leaf moves towards the blocking wall, thus placing this metal leaf under elastic strain.

11. The steering column according to claim 1, wherein the sheet-metal plate includes a frame with a central opening, and the clamp includes a clamping screw passing through this central opening.

12. The steering column according to claim 11, wherein the sheet-metal plate includes an outer frame, the frame with the central opening being inside this outer frame and connected thereto by spacer pieces, the second blocking shapes being borne by the frame with the central opening or by the outer frame.

13. The steering column according to claim 11, wherein the support base includes a blocking wall against which the sheet-metal plate is blocked, the blocking wall including studs arranged on either side of this frame, so as to block the sheet-metal plate, so as to contribute to the blocking of the rotation of the steering member with respect to the support base.

14. The steering column according to claim 11, wherein the sheet-metal plate includes a single frame, the mobile clamping element and the sheet-metal plate being arranged in such a way that, during clamping, the mobile clamping element presses directly against the support base.

15. The steering column according to claim 1, wherein the support base includes a blocking wall on which the sheet-metal plate is blocked, this blocking wall including fixing holes, and in that the sheet-metal plate includes fixing tabs, the tabs being fitted into the fixing holes in such a way as to fix the sheet-metal plate to the blocking wall.

16. The steering column according to claim 1, the support base including a blocking wall on which the sheet-metal plate is blocked, wherein the sheet-metal plate includes a load-reacting shape, the sheet-metal plate including a bow forming a slot in the sheet-metal plate, this load-reacting shape being arranged in this slot in such a way that opposite edges of this load-reacting shape are in contact with corresponding edges of this slot.

17. The steering column according to claim 16, wherein the load-reacting shape is an arch and in that the sheet-metal plate includes a bar extending from one edge of the slot formed by the bow, this bar being designed to slide under strain under the arch.

18. The steering column according to claim 1, the support base including a blocking wall on which the sheet-metal plate is blocked, wherein the sheet-metal plate exhibits a curved edge allowing the sheet-metal plate to be fitted onto the blocking wall.
